(19) United States
(12) Patent Application Publication
(10) Pub. No.: US 2013/0048663 A1
(43) Pub. Date: Feb. 28, 2013

(54) WAFER POCKET ASSEMBLY TO BE INSERTED IN A DISPENSER AND DISPENSER FOR WAFER POCKETS CONTAINING WAFERS

(71) Applicants: Kathrin Reichardt, Berlin (DE); Sven Filler, Oranienburg (DE); Kirsten Gollin, Potsdam (DE); Uwe Karla, Basdorf (DE)

(72) Inventors: Kathrin Reichardt, Berlin (DE); Sven Filler, Oranienburg (DE); Kirsten Gollin, Potsdam (DE); Uwe Karla, Basdorf (DE)

(73) Assignee: BAYER INTELLECTUAL PROPERTY GMBH, Monheim (DE)

(21) Appl. No.: 13/518,884

(22) PCT Filed: Dec. 22, 2010
(86) PCT No.: PCT/EP2010/070461

§ 371 Date: Nov. 12, 2012

(30) Foreign Application Priority Data
Dec. 23, 2009 (DE) 10 2009 060 945.8
Nov. 29, 2010 (DE) 10 2010 062 135.8

(51) Int. Cl. A61J 1/03; B65D 83/08; B65D 85/62

(52) U.S. Cl. 221/1; 206/526; 221/26

(57) ABSTRACT

To ensure reliable administration of medicines present in the form of wafers, to allow the medicines to be easily removed from a dispenser 1, to allow the latter to be easily refilled, and to make it possible to verify, in a manner free of manipulation, a predefined sequence of the wafer pockets 20 in the wafer pocket stack, the invention proposes a dispenser 1 and also a wafer pocket booklet 100 that can be inserted into the dispenser 1 and fixed releasably therein. The wafers are packed in wafer pockets 20. The dispenser 1 according to the invention contains a stack of at least two wafer pockets 20, which each contain a wafer, wherein each wafer pocket 20 has a wafer portion 21, which contains the wafer, and at least one residual portion 24, which remains in the dispenser 1 when the wafer portion 21 is removed. The dispenser 1 further comprises a storage space 9, which receives the wafer pocket stack, and at least one dispensing opening 5 through which a wafer pocket 20 can in each case be dispensed from the dispenser 1 in a dispensing direction A. The wafer pocket stack is held in the dispenser 1 by means of at least one fixing means 19. The wafer pockets 20 are combined and connected to one another in the wafer pocket stack by means of a holding element 10 of a wafer pocket booklet 100 secured releasably in the dispenser 1, by means of the holding element 10 holding and non-releasably fixing the respective residual portion 24 of the wafer pockets 20 by means of the at least one fixing means 19.

### FIELD OF THE INVENTION

The present invention relates to a wafer pocket booklet that can be inserted into a dispenser and fixed releasably therein, and to a dispenser for wafer-containing wafer pockets. Dispensers of this kind are used, for example, for supplying medicines and sweets in wafer form, particularly for hormone medication and very particularly for contraception or for hormone replacement therapy, and for presentations containing analgesics or nicotine.

### PRIOR ART

Wafers (also called edible films, oral films, etc.) are water-soluble carrier substances that contain a suitable amount of an active substance or of several active substances. Wafers are taken orally and dissolve in the oral cavity, with release of the active substance or active substances. The latter can be delivered directly to the blood stream through the oral mucosa.

Medicines or sweets in wafer form can be made available in and stored in a primary package, in which the wafers are enclosed by being sealed or welded between two sealing films, in particular a carrier film and a cover film, or a top film and a bottom film, so as to be impermeable to outside moisture and air. The wafers are removed from these primary packages, by tearing open the sealing films, and administered, in most cases in the oral cavity. For this purpose, the sealing films are detached from each other, or they are torn open, such that the wafer can be removed.

Such a package for films containing active substance is disclosed in DE 10 2006 041 921 A1. This package has a carrier layer, and a cover layer which is connected releasably to the latter. In the particular design of the package disclosed in said document, the package also has two mutually opposite surface areas in a paired arrangement which are separated from each other by a web and within which the cover layer is not connected to the carrier layer, as a result of which two spaces which are separate from each other and are enclosed on all sides are formed for receiving said films in pairs. Moreover, a further surface area in which the carrier layer is not connected to the cover layer is present within said web, as a result of which a hollow space which is enclosed on all sides is formed. Finally, a perforation line is present within the web. The further surface area within the web of the double package forms a tear-open aid, such that the surface required for this is reduced relative to the surface areas that are designed to accommodate the packaged material. The perforation line within the further surface area extends in the direction of this surface area. By making an initial tear in the carrier layer and the cover layer at the perforation line, and by subsequently continuing this tear, the abovementioned further surface area is divided approximately into two halves. By cutting through the two layers of the package, free edges are obtained that can serve as tear-open aid, such that a tear-open aid is produced.

Another embodiment for packaging a wafer is disclosed in DE 10 2004 047 447 B4. The package described therein has a first surface area for the wafer, which in this surface area is enclosed on all sides by a carrier film and a cover film by being sealed or welded in. The package has a second surface area in which the carrier layer is not connected to the cover film. Moreover, a perforation line is present which extends at least partially within the second surface area, the perforation being provided both in the carrier layer and also in the cover layer. Severing the perforation also has the effect of forming a free edge of the cover layer, which free edge serves as a gripping aid and permits manual removal of the cover layer from the carrier layer.

These primary packages can also be made available and ready for use in a secondary package.

For example, DE 101 59 746 A1 discloses a dispensing device for storing and providing stacked film pockets filled with wafers. The film pockets are formed by a carrier film of greater surface area and by a smaller cover film, such that the carrier film protrudes beyond the cover film on one side. The dispensing device comprises a housing which is partitioned at least once and on whose lateral inner faces the side edges of the stacked film pockets bear, while the edge of the carrier film protruding beyond the edge of the associated cover film bears on a front inner face. The film pockets are pressed with spring-loading against the upper inner face of the housing. The front, upper area of the housing has two slits for ejection of the film pocket parts and the wafers. A knife, on which the uppermost carrier film lies spatially in front of the front edge of the cover film, is arranged between the slits. Moreover, on the uppermost film pocket, and bearing thereon, there is a rotatable transport element with which the uppermost film pocket can be conveyed out of the dispensing device. The knife separates the carrier film from the cover film, and the wafer adheres to the cover film. These two films are output separately through the two slits.

Moreover, DE 10 2006 022 198 B4 discloses a multi-pack made up of pouches. This multi-pack contains at least one sealed pouch for a wafer containing active substance, each wafer being stored in a sealed state within a sealed pouch. The sealed pouches are stacked in the multi-pack and secured releasably via predetermined partition lines. Each sealed pouch has a predetermined partition seam that delimits a tear-open area. The gripping piece is connected to the tear-open area. By pulling the gripping piece, the tear-open area is opened and the active-substance-containing product is exposed. Further pulling of the gripping piece separates the predetermined partition line. In the stacked state in the multi-pack, the individual sealed pouches are secured by means of two pins, which extend through the pouches in two through-openings, or are locked in another way with a form fit or force fit. The multi-pack can, for example, be a square box with a lid that folds open, slides open or can be taken off.

Moreover, US 2006/0157374 A1 discloses a child-resistant blister pack container for stacked blister packs. The container comprises a bottom part, a top part, and a rear area in which a device for holding the blister packs is located on the bottom part. The holding device can be formed by a pin, which is pushed through a hole in the blister packs, or by a punch which secures the blister packs in the container. To allow removal, the container has a lid via which a user can access the blister packs. With the lid opened, a blister pack lying at the top can then be removed by the user tearing it off.

The above-described primary and secondary packages for wafers are complicated and, consequently, can be produced only with quite considerable outlay. A further disadvantage is that the wafer pockets are either placed individually into the secondary package (DE 101 59 746 A1, US 2006/0157374 A1) and/or are fixedly connected to the secondary package (DE 10 2006 022 198 B4, US 2006/0157374 A1). This requires the secondary package to be filled with wafer pockets by the user or by a manufacturer, or requires secondary packages already filled with wafer pockets to be made available by the manufacturer. It is thus necessary for the user either to discard the emptied secondary package or return the latter to the manufacturer for refilling. However, filling of the secondary package with wafer pockets by a user is problematic if the wafer pockets have to be inserted into the secondary package in a certain sequence, for example in order to maintain a predetermined treatment regimen. In this case, errors may occur during filling and then adversely affect the stringent observance of the wafers being taken in the specified sequence. The aforementioned problem can be solved if the wafer pockets are secured in the secondary package. However, it is not desirable to discard a secondary package after the wafer pockets have been used up, since this would generate needless waste and, in addition, a new secondary package would have to be made available each time. The alternative possibility, namely that of returning the secondary package to the manufacturer for refilling, is likewise disadvantageous, since this would entail considerable logistical effort.

Therefore, the object of the present invention is to ensure, using customary solutions for providing wafer pockets in a secondary package, an exactly predefined sequence of the pockets in the secondary package with the least possible logistical effort and material outlay, thereby guaranteeing that a treatment regimen can be complied with strictly. After the wafers have been removed from the dispenser, it should also be possible to establish whether the wafers were contained in a predetermined sequence in the dispenser. Moreover, the wafer pockets should be easy to remove from the secondary package.

### SUMMARY OF THE INVENTION

These objects are achieved by the wafer pocket booklet, according to Patent claim 1, that can be inserted into a dispenser and fixed releasably therein and that comprises a stack of at least two interconnected wafer pockets, which each contain a wafer, by the dispenser, according to Patent claim 10, for a stack of at least two wafer pockets, which each contain a wafer, and by the use, according to Patent claim 13, of the dispenser. Preferred embodiments of the invention are set forth in the dependent claims.

The wafers located in the wafer pockets are in particular medicinal wafers, which are preferably used for contraception or hormone replacement therapy.

In so far as certain elements are referred to hereinbelow only in the singular, for example a holding element, a wafer pocket, a receiving space, a wafer portion of a wafer pocket, a residual portion of a wafer pocket, a fixing means, a ridge, a knob, a spike, a receiving opening, a sleeve, a push-through element or a dispensing opening, the plural is also meant in addition in each case, that is to say a plurality, for example, of holding elements, wafer pockets, receiving spaces, wafer portions of a wafer pocket, residual portions of a wafer pocket, fixing means, ridges, knobs, spikes, receiving openings, sleeves, push-through elements or dispensing openings, unless expressly stated otherwise.

The wafer pocket booklet according to the invention can be inserted into a dispenser for wafer pockets and can be fixed releasably in said dispenser. It comprises a stack of at least two wafer pockets, which each contain a wafer, and also a holding element for the stacked wafer pockets. The wafer pockets are connected to each other by the holding element. Each wafer pocket has a wafer portion, which contains the wafer, and at least one residual portion, which remains in the holding element when the wafer portion is removed. The respective residual portion remaining in the holding element is held and non-releasably fixed by means of at least one fixing means.

The dispenser according to the invention contains a stack of at least two wafer pockets, which each contain a wafer, preferably held by a holding element, wherein each wafer pocket has a wafer portion, which contains the wafer, and at least one residual portion, which remains in the dispenser when the wafer portion is removed. The dispenser also has a storage space, which receives the wafer pocket stack, and at least one dispensing opening through which a wafer pocket can in each case be dispensed from the dispenser in a dispensing direction. The wafer pocket stack is held in the dispenser by means of at least one fixing means. According to the invention, the wafer pockets in the wafer pocket stack are combined and connected to one another by means of a holding element of a wafer pocket booklet secured releasably in the dispenser, by means of the residual portion of the wafer pockets being held and non-releasably fixed by means of the at least one fixing means. Thus, the wafer pocket booklet comprises a holding element and at least one fixing means. By means of the wafer pockets being mounted and fixed in the holding element, the at least one residual portion of a wafer pocket, which residual portion remains in the holding element during dispensing of the wafer portion, is secured in the dispenser.

By arranging the wafer pocket booklet in the dispenser, the used booklet can be exchanged, after all the wafers have been used up, and can be replaced by a new wafer pocket booklet. It is thus possible to use the dispenser more than once. In addition, the sequence of the wafer pockets is in this way predefined by the manufacturer. It is therefore not possible for the user to mix up the wafer pockets. The presence of the fixing means additionally ensures that a residual portion of the wafer pockets remains in the holding element, with the result that the sequence of the wafer pockets can subsequently be checked, such that manipulation could be easily identified.

### DETAILED DESCRIPTION OF THE INVENTION

The holding element is designed to hold and non-releasably fix the residual portion remaining in the holding element. The residual portion of each wafer pocket is fixed, preferably clamped, in the holding element by means of the at least one fixing means in particular. This means that the wafer pockets are held in the holding element with a force fit and/or form fit.

In a preferred embodiment of the invention, the at least one fixing means is designed in the form of a ridge, a knob, a spike, a rubber ring, a front holding edge, or in the from of a receiving opening that receives a push-through element. Of course, other fixing means with a force-fit and/or form-fit action are also conceivable. Several such fixing means can also be present in combination. Fixing means with a force-fit (clamping) action are particularly preferred.

If, for example, receiving openings are used as fixing means, these can, for example, receive the push-through elements. The push-through elements can be designed, for example, in the from of rivets, screw connections, nails or staples. In particular, the receiving openings can receive sharp, needle-shaped ends of staples, marking tools, nails or rivets.

These push-through elements pass through the residual portions of the wafer pockets, or through the stack in the region of the residual portions of the wafer pockets, in order to secure the residual portions in the holding element. The receiving openings can be designed as blind holes or as through-holes. A receiving opening can receive the push-through element with a form fit, for example, by locking, or also with a force fit.

For example, at least one receiving opening can be located in a sleeve arranged in the holding element. The receiving opening can be formed in particular axially in the sleeve. The opening can be formed primarily by a blind hole in the sleeve. In order to fix the wafer pockets, a push-through element is pushed through the respective residual portion of the wafer pockets and into the receiving opening in the sleeve and is locked there or secured with a force fit. Thus, the holding element can contain at least one sleeve with a receiving opening, and, in the assembled state of the holding element, the end of a push-through element is pushed into the receiving opening of each sleeve.

If ridges or knobs are used as fixing means, these can be provided, on the face touching the wafer pocket stack, with a rough surface, in order to prevent the residual portions of the wafer pockets being removed from the stack. Alternatively, these faces can also be designed with a sharp edge or tapering to a point, for example with one edge or one point or also with several edges, for example edges extending parallel to one another, or with several points, for example points arranged in a regular matrix.

When using several fixing means, these can be used individually or in combination in the holding element.

Moreover, in order to ensure that the fixing means not only hold and non-releasably fix the residual portions of the outer wafer pockets of a wafer pocket stack in the holding element, but also the other residual portions arranged between these two outer residual portions, all of the residual portions can be connected to one another with a force fit, a form fit or, in particular, a materially cohesive fit, for example by welding or adhesive bonding.

In a preferred embodiment, the holding element has at least one wall, preferably a rear wall, side walls, a base plate and a cover plate, such that a receiving space is formed for the residual portions of the wafer pockets. Moreover, the receiving space can, on at least one side of the holding element, be open to the storage space. For example, a connection opening to the storage space can be located in at least one side wall, through which connection opening the at least one wafer pocket extends with its residual portion into the receiving space.

In a preferred embodiment of the invention, the wafer pockets are fixed non-releasably between the base plate and the cover plate via the respective residual portions. For example, the residual portions are clamped between the base plate and the cover plate. The base plate and/or the cover plate preferably have/has the at least one fixing means for fixing the at least one wafer pocket.

In a preferred embodiment of the invention, the cover plate and/or the base plate can each have at least one ridge and/or at least one spike and/or at least one knob as fixing elements.

In another embodiment of the invention, receiving openings as fixing elements, into which push-through elements can be inserted, can be formed for example either in the base plate or in the cover plate. When using several fixing means, these can be used individually or in combination. If, for example, one or more receiving openings are formed in the base plate, one or more fixing means in the form of ridges, knobs or spikes can additionally be provided on the cover plate. Correspondingly, the receiving opening(s) can also be formed in the cover plate and the other fixing means in the base plate. In a preferred embodiment of the invention, the cover plate and/or the base plate can each have a ridge for fixing the wafer pockets. Alternatively, at least one knob or at least one spike can also be provided on the cover plate and/or on the base plate. Or a ridge can be provided on the cover plate, and at least one spike or at least one knob on the base plate, or vice versa.

In a particularly preferred embodiment of the invention, the base plate has at least two receiving elements, for example sleeves, which each contain a hole and into which, for example, the ends of a staple-like element, which holds at least one wafer pocket in the residual portion thereof, are received with a force fit or form fit. In addition, the cover plate can have one or more ridges, knobs or spikes as fixing element(s).

In a preferred embodiment of the invention, the holding element is designed as a holding block. The holding block can have at least one wall, in particular a rear wall, side walls, a base plate and a cover plate, which together form a receiving space for the residual portion of the wafer pockets. The receiving space is open towards the storage space, such that the wafer pockets can extend with their residual portions into the receiving space. For example, a connection opening leading to the storage space can be located in at least one side wall.

In a preferred embodiment, two walls of the holding element are designed such that, when a tensile force or transverse force is applied to the wafer pocket in the dispensing direction, the wafer portion detaches from the residual portion located in the receiving space, and the residual portion thus remains in the holding element.

In a particular embodiment of the wafer pocket, the wafer portion containing the wafer is connected to the at least one residual portion at least in some parts via at least one predetermined break line, which in turn has at least in some parts an extension component parallel to the dispensing direction of the wafer pockets from the dispenser.

According to the invention, the wafer pockets are stacked together in the dispenser to form a stack and are held together and fixed by the holding element. A wafer pocket booklet is formed in this way. The wafer pocket booklet is accommodated in the dispenser. The wafer portion of the wafer pocket containing the wafer is detached from the stack by being torn off and dispensed from the dispenser in the dispensing direction. After the wafer pockets have been used up, a new wafer pocket booklet can be inserted into the dispenser.

If the wafer portion is connected by a predetermined break line to the residual portion, which remains in the dispenser after the wafer portion has been dispensed, and the predetermined break line preferably has at least in some parts an extension component parallel to the dispensing direction of the wafer pockets from the dispenser, this makes removal of a wafer pocket from the dispenser very easy since, by means of the tensile force in the dispensing direction, the wafer portion can in this way be easily separated from the at least one residual portion. The dispensing of the wafer pocket from the dispenser is facilitated in this way.

The extension component of the predetermined break line, which extends parallel to the dispensing direction of the wafer pockets from the dispenser, is the directional component of the predetermined break line, at least of a section of the predetermined break line, that is obtained by an orthogonal division of the direction of the predetermined break line into a direction parallel to the dispensing direction and into a direction perpendicular thereto. Therefore, if the predetermined break line extends at an angle of >0° and <90° with respect to the dispensing direction, the predetermined break line has both an extension component extending parallel to the dispensing direction and also an extension component extending perpendicularly thereto. If the angle between the predetermined break line and the dispensing direction is 0°, the predetermined break line exclusively has an extension component parallel to the dispensing direction. In this case, the order of the extension component is the same as the length of the predetermined break line. If the angle between the predetermined break line and the dispensing direction is 90°, the predetermined break line exclusively has an extension component perpendicular to the dispensing direction, and no extension component parallel to the dispensing direction. The angle of the predetermined break line with respect to the dispensing direction is preferably 0°, i.e. the predetermined break line extends parallel to the dispensing direction, or alternatively 90°, i.e. perpendicular thereto. If the angle is not 0° but instead <0°, it should at least in part be smaller than 75° and preferably smaller than or equal to 45°.

If the predetermined break line between the wafer portion and the at least one residual portion has an extension component parallel to the dispensing direction, the wafer portion of a wafer pocket can be easily detached from the at least one residual portion of the wafer pocket when a tensile force is applied to the wafer pocket in the dispensing direction. This permits easy removal of a wafer pocket from the dispenser.

In a preferred embodiment of the invention, two predetermined break lines are present, in which case the predetermined break lines are perforation portions.

In another preferred embodiment of the invention, the wafer portion adjoins the at least one residual portion in some parts via the at least one predetermined break line and in addition via at least one incision in the wafer pocket.

In another preferred embodiment of the invention, the wafer pocket booklet comprises 28 or 30 wafer pockets connected to one another in a stack.

The wafer pocket booklet according to the invention is located for use in the dispenser according to the invention. For this purpose, the holding element can be held in its position in the dispenser with a form fit or force fit by securing means, for example rails or locking elements. The holding element is secured releasably in the dispenser, such that it can be removed again from the dispenser after the wafer pockets have been used up. After the wafer pockets have been used up and the old holding element with the remaining residual portions has been removed, a new wafer pocket booklet can be secured by its holding element in the dispenser.

By virtue of the fact that a booklet of wafer pockets bound together by a holding element can be introduced into the dispenser and secured therein, the wafer pocket booklet can be handled, in particular manufactured, stored, sold and supplied to a user, independently of the dispenser. The user, finally, can handle this booklet separately, for example insert it independently into a dispenser or simply store it until he/she wishes to use the booklet. A sequence of wafer pockets defined in such a booklet during the manufacturing process is therefore maintained at each handling stage. Individual wafer pockets cannot therefore be mixed up. For this reason, a predefined administration regimen, for example with differently marked wafer pockets, can easily be complied with by a user, and the sequence initially adopted during the manufacture of the wafer pocket stack is not altered prior to arrival at the user or through improper handling by the user. Moreover, the remaining residual portions of the wafer pockets mean that, when so required, the presence and the sequence of the wafer pockets in the wafer pocket booklet can be identified at any time.

Moreover, the invention also has the advantage that the user does not have to acquire the wafer pocket booklet together with the dispenser and mounted therein. Instead, it suffices for the user to separately acquire the wafer pocket booklet in which the wafer pockets are connected to one another. The fact that the wafer pockets in the stack are connected by means of the holding element also ensures that the sequence of the wafer pockets is not altered during handling. As a result, the dispenser can be used more than once, i.e. after the wafer pockets have been used up, the user does not have to discard the dispenser or return it to the manufacturer. The latter option would entail a considerable logistical outlay.

A wafer pocket typically consists of a carrier film and a cover film, or of a bottom film and a top film. The cover film or top film can be connected, for example bonded, sealed or welded, to the carrier film or bottom film via a preferably strip-shaped connection extending along the side edges of the cover film or top film, or vice versa. Moreover, in a particularly preferred embodiment, the carrier film or bottom film and the cover film or top film can each have, on at least one side edge, protruding tabs, which are not connected to each other. This makes it much easier to pull apart and thus open the wafer pockets in order to remove the wafer contained therein, because the two films can be easily gripped. It is also possible to open the wafer pocket using tear-in notches. Inside a portion formed by the connection, a wafer is enclosed, preferably in an airtight and moisture-proof manner, between the carrier film or top film and the cover film or bottom film. The film pockets can have a small raised area, which is either a result of their structure or is caused by the wafer and is provided only in the area thereof.

The dispenser according to the invention can preferably be used for storing and supplying medicinal wafers for which a strict administration regimen is desirable or required.

The dispenser according to the invention typically comprises a base part and a cover part. These two parts can each be designed in particular in the form of half shells and, when connected, form the storage space. The two parts can be connected to each other in particular with a force fit or form fit. For example, the cover part can be mounted on the base part and locked onto the latter. The two parts should remain firmly connected to each other during use, in order to ensure that a wafer pocket stack contained in them cannot fall back out. However, the cover part should also be easily removable (releasable) from the base part, so as to be able to insert a new wafer pocket booklet with wafer pocket stack into the dispenser. In an alternative embodiment, the shells can be designed to be movable relative to each other, for example parallel to the dispensing direction. For this purpose, the shells can be designed with a linear guide, for example a linear sliding guide. In another alternative embodiment, the base part and the cover part can be articulated on each other. For example, the cover part can consist of two individual parts, which are each articulated on the base part, preferably on the narrow sides of the base part. Of course, the base part can also consist of two individual parts, which are each articulated on the cover part, preferably on the narrow sides of the cover part. The base part and the cover part are preferably formed in such a way that the dispenser has a substantially rectangular shape, it being possible for the exact shape to be influenced by ergonomic or design considerations, for example with a lateral gripping recess or gripping flutes or other structures and/or rounded and/or bevelled edges and corners.

During the use of the dispenser, the latter contains the wafer pocket booklet with a stack of wafer-containing wafer pockets. This stack is held together by the holding element. The unit composed of the holding element and of the wafer pocket stack held by the holding element, in which the holding element is sealed according to the invention against unauthorized or inadvertent removal of the wafer pockets and of the residual portions, for example by a fixedly connected holding module lid, can be secured in particular releasably in the dispenser, such that this unit can be easily inserted and such that the wafer pocket booklet, or the holding element with the remaining residual portions of the wafer pocket booklet, can be easily removed again after the wafers have been used up. For this purpose, in order to position the holding element of the wafer pocket booklet, it is possible to use securing means in the form of suitable snap-fit connections known to a person skilled in the art, suitable rails or locking elements, or, for example, also a velcro-type fastener, or just a compartment into which the holding element is fitted. Alternatively, a force-fit connection can also be provided, for example by pressing the holding element into a depression or a compartment in the dispenser. In any event, a suitable device for releasably holding the holding element is provided if necessary on the inside of the dispenser.

The holding element, which holds the wafer pocket stack, is preferably inserted into the dispenser in such a way that the wafer pockets can be individually detached from the holding element. For this purpose, an arrangement is particularly preferably chosen in which an uppermost wafer pocket can be detached, for example torn off, from the holding element parallel to the main direction of extent of the wafer pocket. In an advantageous embodiment of the invention, the holding element is therefore mounted in particular in an edge area of the dispenser, on the inside thereof, such that the wafer pockets can be detached from the holding element by lateral pulling and can be removed in succession from the dispenser. The direction in which a wafer pocket is detached from the stack by being torn off is preferably identical to the direction in which the wafer pocket is dispensed from the dispenser. Therefore, in the dispenser, a dispensing direction can be defined in which the wafer pockets are pushed out of the dispenser.

In the alternative embodiment, the wall separating the receiving space of the holding element from the storage space in the dispenser can be designed in particular in such a way that, when a tensile force is applied to the wafer pocket in the dispensing direction of the wafer pocket from the dispenser, the wafer portion of the wafer pocket easily detaches from the residual portion of the wafer pocket extending into the at least one receiving space. It is particularly preferable if the wall separating the receiving space from the storage space is designed in the form of a notching tool for separating the residual portion extending into the at least one receiving space. The notch effect of the notching tool permits easy detachment of the wafer portion from the residual portion remaining in the receiving space. In this way, that part of the wafer pocket containing the wafer can be detached with low tensile force from the holding element and thus removed from the dispenser. In particular, the wall can have a notch edge acting counter to the dispensing direction of the wafer pocket from the dispenser. For this purpose, the wall, for example by being bevelled on one side or both sides toward the edge, can form a cutter on the notch edge.

In a particularly expedient embodiment of the invention in which several receiving spaces are provided in the holding element, the dispenser according to the invention is designed such that a holding element with two receiving spaces for a respective residual portion can be received therein. The residual portions received by the receiving spaces of this holding element can be provided in each case on one of two corners of the wafer pocket. Between the two receiving spaces of the holding element, another space open towards the storage space can be provided for the wafer pocket, into which space a central area of the wafer pocket protrudes. When the wafer portion is separated from the residual portions extending into the receiving spaces, this central area preferably remains connected to the main part of the wafer pocket and can in particular serve as a tear-open aid, for example if the carrier film or bottom film and the cover film or top film are not connected to each other in this area. Thus, the holding element, which has two receiving spaces with in each case one connection opening and with in each case one wall for separating the respective receiving space from the storage space, can be provided to receive in each case two residual portions at adjacent corners of the wafer pocket.

It is also particularly advantageous if the holding element designed in the form of a holding block in the first particularly preferred embodiment preferably has a rear wall, arranged on a long side, and two side walls, arranged on narrow sides, which adjoin each other and sit on a base plate, and on which a cover element is placed. Moreover, one or more fixing means are arranged on the base plate and/or cover plate. After the wafer pockets have been inserted, a cover plate can be placed on the residual portions of the wafer pockets and secured on the side walls. The residual portions are thus securely clamped, such that the wafer pockets are held securely in the holding block. The cover plate is intended in particular to prevent the residual portions being able to fall out or be taken out of the receiving spaces, and therefore the wafer pockets in the wafer pocket stack are connected to the holding block with a force fit and/or form fit. For example, the cover plate can be connected to the upper edges of the walls with a force fit or also with a form fit and/or materially cohesive fit. For example, recesses are provided in the upper area of the walls, in which recesses the projections, e.g. webs, on the cover plate engage by locking for example, and/or the cover plate is welded or bonded to the walls. The cover plate is preferably welded to the walls, for example by ultrasound. The cover plates can alternatively have locking elements, e.g. locking webs or locking tabs, which lock with a form fit in recesses of the side walls or of the rear wall and of the side walls. All of the connection options should be configured in such a way that opening leads to visible destruction of the holding element.

The holding element can be arranged on a side of the dispenser lying opposite the dispensing opening for the wafer pockets. The dispensing opening can be designed in particular in the form of a dispensing slit.

To be able to dispense a wafer pocket from the dispenser without obstruction, a run-on bevel for an emerging wafer pocket is preferably formed in the storage space, which run-on bevel guides the emerging wafer pocket through the dispensing opening.

To be able to dispense an uppermost wafer pocket from the dispenser, a grip opening, which allows the uppermost wafer pocket to be pushed forward manually, can be formed in a main outer surface of the dispenser, for example in the cover part. This grip opening is preferably formed in the outer surface of the dispenser so as to be elongate and run parallel to the dispensing direction. Through this grip opening, the uppermost wafer pocket can be pushed forwards by a finger and pushed out through the dispensing opening.

Alternatively, a device can be present as in the case of DE 10 2008 014 533 A1, that is to say a transport roller or a transport wheel, which is in force-fit contact with the uppermost wafer pocket and conveys the latter out of the dispenser when manually rotated.

Moreover, a display surface can be provided on the dispenser according to the invention, which display surface adjoins the dispensing opening and on which time information can be applied. This time information can be, for example, in the form of calendar dates, in particular days of the week. In the latter case, seven fields arranged next to one another can be applied to the display surface, preferably parallel to the dispensing slit. The time information can be applied to the display surface by, for example, affixing a label showing the time information. The time information is applied individually by the user.

This time information means that, when a wafer pocket is dispensed, the user can verify whether this wafer pocket is removed within a prescribed time interval. To do this, the wafer pockets also each have a marking in one of several marking portions arranged next to one another in an area adjoining a marking edge on the wafer pocket, and the respective markings within the stack are arranged stepwise in successive marking portions from one wafer pocket to the next. The marking portions on the marking edge are arranged next to one another corresponding to the time information fields on the dispenser and, when a wafer pocket is dispensed, are flush with this. For this purpose, the width of the time information fields on the display surface and the width of the marking portions are in particular of the same size. In the case of an administration regimen involving daily administration of one wafer, the time information is in the form of days of the week. In this case, seven such days are shown on the display surface. In the same way, seven marking portions, each with one marking, are provided on each wafer pocket. When a wafer pocket is dispensed, the marking on this wafer pocket is flush with one of the days of the week, such that the user can verify whether the marked day of the week coincides with the actual day of the week.

The dispenser according to the invention is preferably forgery-proof. For this purpose, one or more security features can be provided on the dispenser to make it possible to verify that the dispenser is genuine, for example imprints in microscript, holograms, tilt images or other security features. In the same way, security features of this kind can also be provided on the wafer pockets in order to be able to exclude the possibility of forgery.

The figures described below show preferred embodiments according to the invention. However, the invention is not limited to these embodiments. The latter serve merely to illustrate the invention.

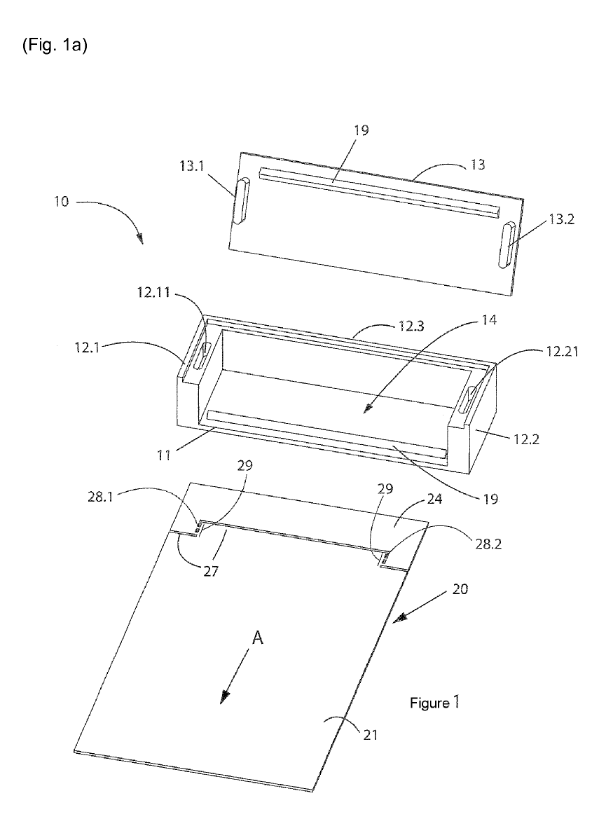

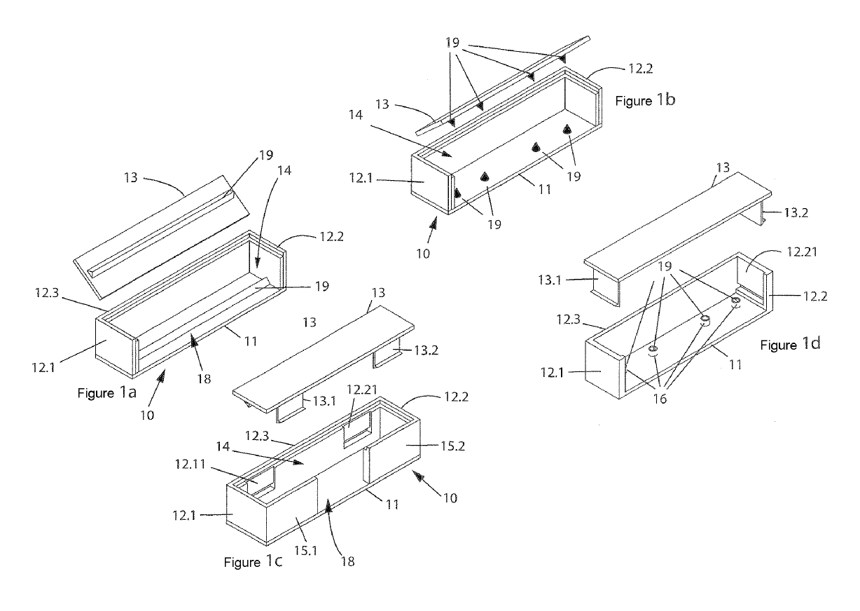

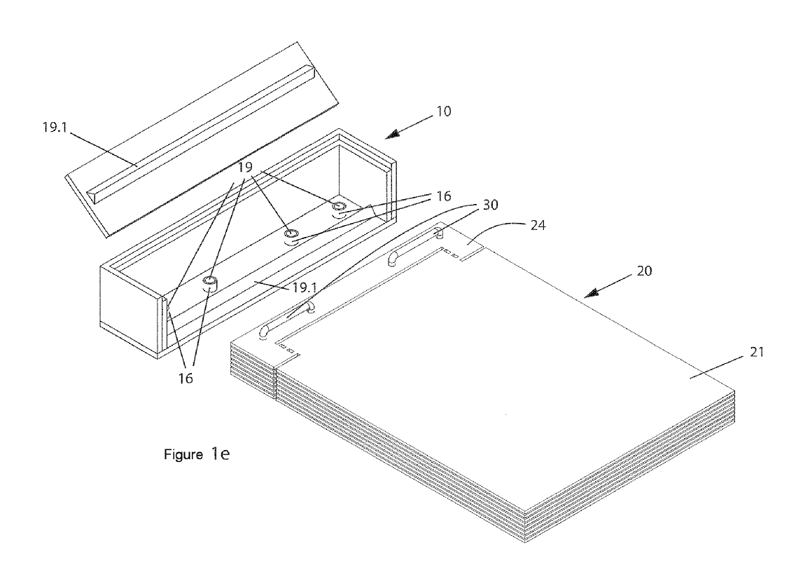

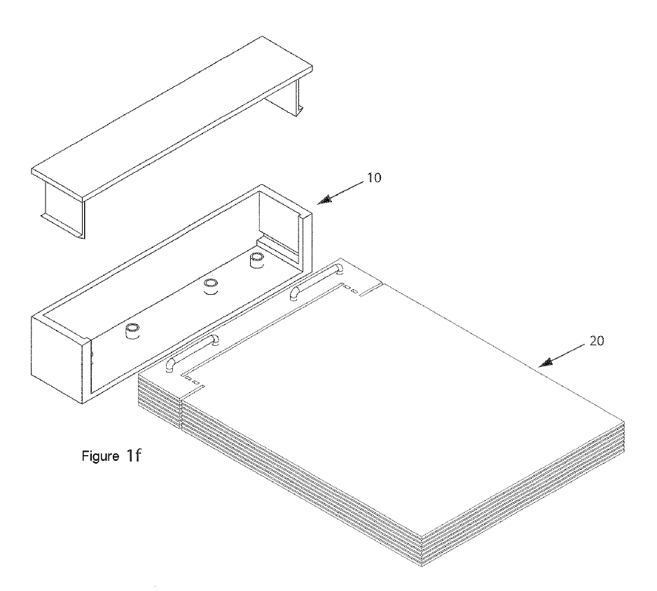

FIG. 1 shows a perspective view of a holding element, here an upwardly open holding block, with a separately depicted cover plate and a wafer pocket that can be inserted into the holding block, in a first embodiment according to the invention;

FIG. 1a shows an upwardly open holding block in a first embodiment according to the invention similar to FIG. 1;

FIG. 1b shows an upwardly open holding block in a second embodiment according to the invention;

FIG. 1c shows an upwardly open holding block in a third embodiment according to the invention;

FIG. 1d shows an upwardly open holding block in a fourth embodiment according to the invention;

FIG. 1e shows a perspective view of a stack of wafer pockets, with a holding block with opened cover plate in a fifth embodiment according to the invention;

FIG. 1f shows a perspective view of a stack of wafer pockets with a holding block with opened cover plate in the fourth embodiment according to the invention as in FIG. 1d;

FIG. 1g shows a perspective view of a stack of wafer pockets with a holding block with opened cover plate in the third embodiment according to the invention as in FIG. 1c;

FIG. 1h shows a perspective view of a wafer pocket in a variant of the embodiment shown in FIG. 1;

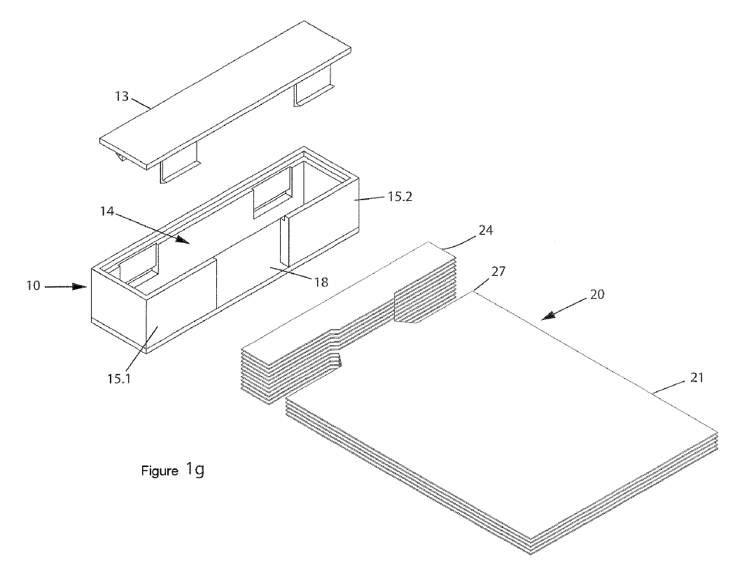

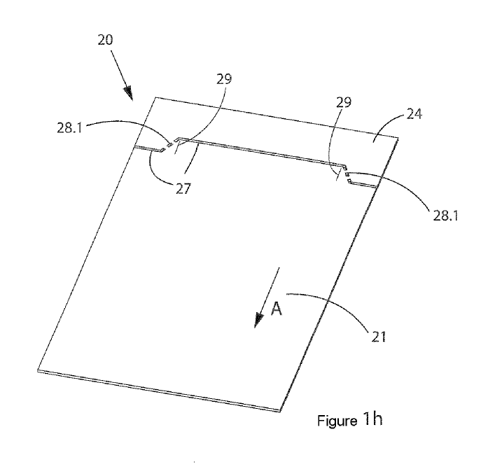

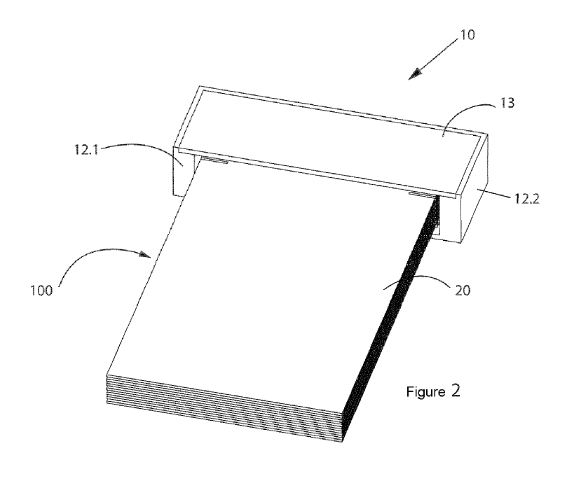

FIG. 2 shows a perspective view of a wafer pocket booklet that is obtained by mounting a wafer pocket stack in a holding block, in the first embodiment according to the invention as in FIG. 1;

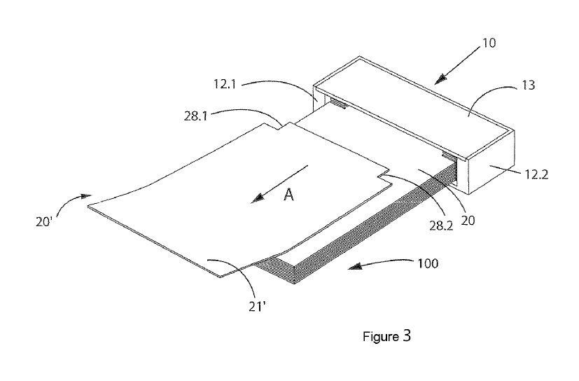

FIG. 3 shows a perspective view of the wafer pocket booklet from FIG. 2 after the uppermost wafer pocket has been torn off;

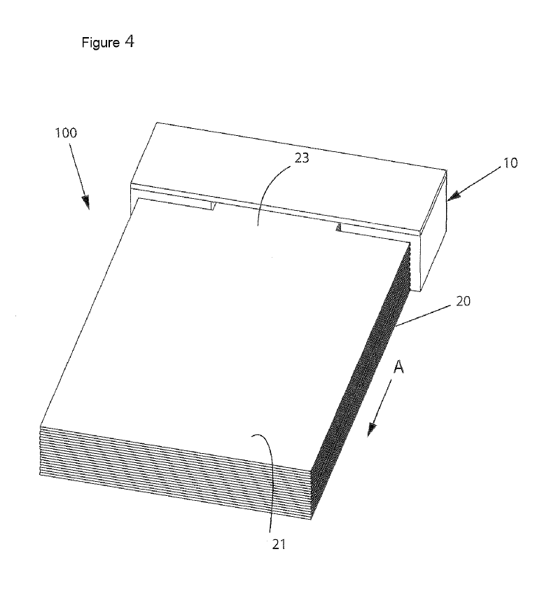

FIG. 4 shows a perspective view of a wafer pocket booklet with a stack of wafer pockets held together by means of a holding block, in the third embodiment according to the invention as in FIG. 1c;

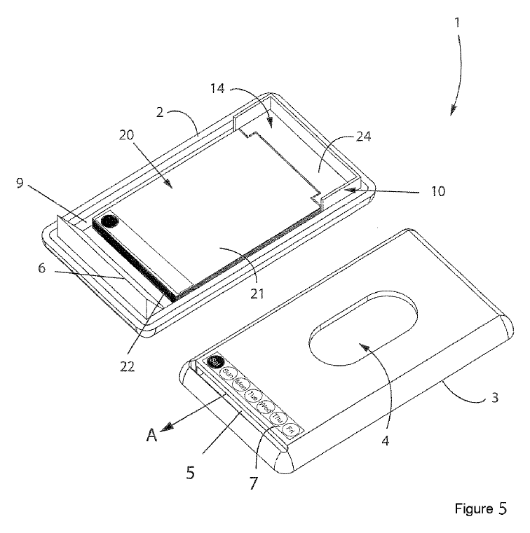

FIG. 5 shows a perspective view of the base and cover parts forming a dispenser according to the invention, with an inserted holding block as in FIG. 1c;

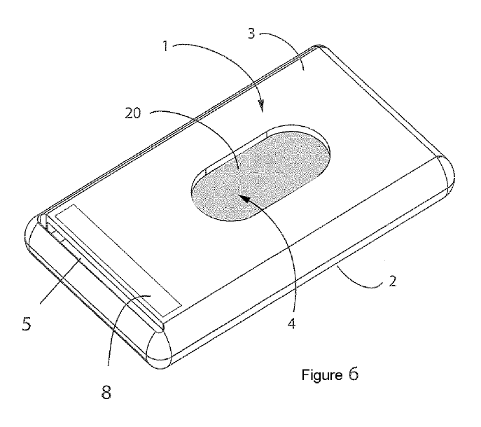

FIG. 6 shows a perspective view of a dispenser according to the invention in the state ready for use;

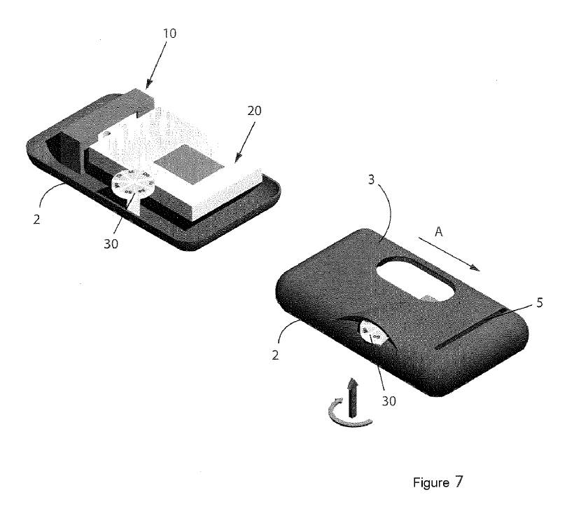

FIG. 7 shows a perspective view of a dispenser according to the invention with a rotatable indicator wheel.

Identical reference signs in the figures in each case designate elements having an identical function.

The holding block 10 shown in FIG. 1 in the first embodiment according to the invention comprises a base plate 11, side walls, namely a left-hand wall 12.1 and a right-hand wall 12.2, and also a rear wall 12.3, and a cover plate 13, which together form a receiving space 14. The base plate 11 and the cover plate 13 each have fixing elements 19. These fixing elements 19 are designed as prismatic ridges with a triangular cross section. The ridges lie with one of their surfaces on the base plate 11 or cover plate 13, respectively, and extend parallel to the rear wall 12.3. One edge of the ridges faces in the direction of the residual portions 24 of the wafer pockets 20, such that the residual portions 24 are held and non-releasably fixed between the ridges 19 when the holding block 10 is closed. To close the holding block 10, the cover plate 13 is placed onto the walls 12.1, 12.2, 12.3 and connected non-releasably, in order to assemble the holding block 10 with the wafer pockets 20 located therein. The holding block 10 holds the wafer pockets 20 and thus fixes them via the fixing elements 19. The cover plate 13 also has locking elements in the form of locking webs 13.1, 13.2 which, upon assembly of the holding block 10, engage in corresponding recesses 12.11, 12.21 of the walls 12.1, 12.2 and are locked therein.

The wafer pocket 20 has a wafer portion 21 and a residual portion 24. The wafer portion 21 and the residual portion 24 adjoin each other via incisions 27 in the wafer pocket 20. In the area of the incisions 27, the wafer portion 21 and the residual portion 24 are not connected to each other. The wafer portion 21 and the residual portion 24 are only connected to each other via two perforation portions, namely a left-hand perforation portion 28.1 and a right-hand perforation portion 28.2. These two perforation portions 28.1, 28.2 extend parallel to a dispensing direction A of the wafer pocket 20, in which direction the wafer portion 21 is removed from the dispenser. The perforation portions thus have extension components (shown by lines 29) parallel to the dispensing direction A.

FIG. 1a shows one of several alternatives of an as yet unclosed holding block 10 in the first embodiment according to the invention similar to FIG. 1. In this embodiment, the base plate 11 and also the cover plate 13 each have a ridge 19, these ridges 19 being designed as fixing elements 19. In this embodiment, the ridges 19 are triangular, with one edge of the triangular ridges 19 in each case facing into the interior of the holding block 10, i.e. the receiving space 14, in order to fix the residual portions of the wafer pockets. The rear wall 12.3 and the side walls 12.1 and 12.2 are stepped toward the receiving space 14, so as to be able to secure the lid 13.

FIG. 1b shows another of several alternatives of an as yet unclosed holding block 10 in a second embodiment according to the invention. In contrast to the embodiment in FIG. 1a, the fixing elements in this case are designed as spikes 19. Four spikes 19 are arranged on the base plate 11, and four on the cover plate 13.

FIG. 1c shows another of several alternatives of an as yet unclosed holding block 10 in a third embodiment according to the invention. In this embodiment, the holding block 10 additionally has the side walls 15.1, 15.2 with, located between these, a connection opening 18. In this way, the residual portions of the wafer pockets (not shown) to be inserted can be better retained in the receiving space 14 of the holding block 10 when the wafer portions 21 are detached. In this embodiment, the residual portions and the wafer portions are connected to each other (not shown) only in the area of the connection opening 18. In this embodiment, the rear wall 12.3 has recesses 12.11, 12.21. The side walls 15.1, 15.2 also each have recesses (not shown). Locking tabs 13.1, 13.2 on the cover plate 13 engage in the recesses 12.11, 12.21 in the rear wall 12.3 and in the recesses in the side walls 15.1 and 15.2 and lock therein. In this way, the cover plate 13 is secured in the holding block 10.

FIG. 1d shows another of several alternatives of an as yet unclosed holding block 10 in a fourth embodiment according to the invention. In contrast to FIG. 1a,the fixing elements are in this case designed in the form of holes 19, which are introduced in sleeves 16. Four such sleeves 16 are located on the base plate 11. Similarly to FIG. 1c, the cover plate 13 has locking tabs 13.1, 13.2, which engage in recesses 12.11 (not visible), 12.21 in the side walls 12.2, 12.3 and lock therein.

FIG. 1e shows a perspective view of a stack of wafer pockets 20 with an as yet unclosed holding block 10 in a fifth embodiment according to the invention. The holding block 10 has a combination of fixing elements 19, here ridges 19.1 on the base plate 11 and on the cover plate 13, and four holes 19.2 in sleeves 16 on the base plate 11. The wafer pockets 20 are substantially identical to the wafer pocket 20 in FIG. 1, the residual portion 24 additionally being provided with push-through elements 30 in the form of staples for holding the wafer pockets 20 or the stack together. The rear parts of the connection elements 30 are shown. The opened staples engage with their open ends in the holes 19 of the sleeves 16 and thus fix the wafer pocket stack in the holding block 10. The wafer pocket stack is additionally fixed by the ridges 19.1 on the base plate 11 and on the cover plate 13.

FIG. 1f shows a perspective view of a stack of wafer pockets 20 with an as yet unclosed holding block 10 in the variant of the fourth embodiment according to the invention as in FIG. 1d.

FIG. 1g shows a perspective view of a stack of wafer pockets 20, some of which have already been used, with an as yet unclosed holding block 10 in the variant of the third embodiment according to the invention as in FIG. 1c. Compared to the wafer pocket 20 in FIG. 1, the incision 27 on both sides of the wafer pocket 20 is made wider, such that the side walls 15.1, 15.2 pass through these incisions 27 when the wafer pockets 20 are inserted into the holding block 10. The residual portion 24 is connected to the wafer pocket portion 21 only in the area of the connection opening 18. In this way, the wafer pocket portions 21, when they are removed, can be more easily separated from the residual portions 24.

A variant of the wafer pocket 20 is shown in FIG. 1h. This differs from the one shown in FIG. 1 in that the perforation portions 28.1, 28.2 do not extend parallel to the dispensing direction A and are instead at an angle ≠0° thereto. The resulting extension components 29 parallel to the dispensing direction A are likewise shown.

Referring further to FIG. 1, the wafer pocket 20 is fitted into the holding block 10. In this way, the residual portion 24 of the wafer pocket is located in the holding block 10, while the wafer portion 21 is located outside the holding block 10. After twenty-eight or thirty wafer pockets 20, for example, have been placed in the holding block 10, the cover plate 13 is mounted onto the walls 12.1, 12.2, 12.3 and locked there and/or also welded there, for example by means of ultrasound.

A wafer pocket booklet 100 assembled in this way, and consisting of the holding block 10 and of the stack of wafer pockets 20, is shown in FIG. 2.

FIG. 3, moreover, illustrates the wafer portion 21′ of an uppermost wafer pocket 20′ having been torn out of the holding block 10. To do this, a pulling force has been exerted in the dispensing direction A, such that the wafer portion 21′ of the uppermost wafer pocket 20′ is torn off, in the area of the previous perforation portions 28.1, 28.2, from the residual portion (not shown), which remains in the holding block 10.

FIG. 4 shows a wafer pocket booklet 100 formed by an assembled stack of wafer pockets 20 and by a holding block 10, which is similar to the embodiment according to the invention as in FIG. 1g and which holds the wafer pockets 20 together.

FIG. 5 shows the base part and cover part that form a dispenser 1 according to the invention. The base part is designated by reference number 2 and the cover part by reference number 3. A holding block 10 with wafer pockets 20, which are held together in a stack by the holding block 10, is inserted into the base part 2. For purposes of illustration, the holding block 10 is shown in the opened position, that is to say the cover plate is not fitted thereon. In normal operation, however, the holding block 10 is closed by means of the cover plate, such that the wafer pockets 20 cannot fall out or be taken out. The cover plate is provided with fixing elements 19 that press the residual portions 24 from the central area of the wafer portions 21. The holding block 10 is locked into the base part 2, such that it cannot fall out, even when the dispenser 1 is opened. In addition, the holding block 10 and the whole stack of wafer pockets 20 are secured in the base part 2 in order to push the uppermost wafer pocket 20 out of the dispenser 1. The parts 2, 3 together form a storage space 9 for the stack of wafer pockets 20.

After the holding block 10 with the stack of wafer pockets 20 has been inserted, the cover part 3 is fitted onto the base part 2 and releasably connected thereto, such that the stack of wafer pockets 20, including the holding block 10, can be easily replaced.

To dispense the uppermost wafer pocket 20 from the dispenser 1, said wafer pocket 20 is manually pushed out in the dispensing direction A using a finger placed through the opening 4 in the cover part 3. A combined pressing/pulling force is thus exerted on the uppermost wafer pocket 20, such that the uppermost wafer portion 21 of the wafer pocket 20 is torn off from the residual portion 24 of the wafer pocket 20 remaining in the receiving space 14 of the holding block 10 and detaches from the holding block 10. To dispense the wafer portion 21 of this uppermost wafer pocket 20 after it has become detached from the rest of the wafer stack, a dispensing slit 5 is present in the cover part 3, which dispensing slit 5 is located on a narrow side of the cover part 3 and, for example, on the side edge of the cover part 3. To ensure that the detached uppermost wafer pocket 20 is safely guided into and through the dispensing slit 5, a run-on bevel 6 is present in the base part 2 and is located on the inner wall of the base part 2 on the narrow side lying opposite the narrow side on which the holding block 10 is secured, specifically in the area of the dispensing slit 5. By means of the force exerted on the uppermost wafer pocket 20 in the dispensing direction A, the wafer portion 21 of the uppermost wafer pocket 20, after being detached from the holding block 10, is carried in the dispensing direction A and moves over the run-on bevel 6 and directly out through the dispensing slit 5, where it can be removed by the user.

Moreover, a strip 7 showing the days of the week and applied by the user can be seen on the cover part 3, which strip 7 is applied to a display surface adjoining and parallel to the dispensing slit 5. Seven fields for the days of the week are arranged alongside one another and are flush with corresponding marking portions in an area adjoining a marking edge 22 on the wafer pockets 20 when a wafer pocket 20 is dispensed from the dispensing slit 5. On each wafer pocket 20, a marking is located on one of the marking portions and, flush with one of the fields for the days of the week, thus shows on which day of the week the wafer contained in the dispensed wafer portion 21 of the wafer pocket 20 is to be taken (not shown). It is thus possible to consistently monitor the administration of the respective wafers. Wafer pockets 20 arranged in succession in the stack contain the markings in successive marking portions, since the wafers contained in the wafer pockets 20 are intended to be administered on successive days. Other administration cycles can also be predefined in a corresponding manner.

FIG. 6 shows the dispenser 1 according to the invention in the state ready for use. For this purpose, the cover part 3 is mounted on the base part 2. Both parts 2, 3 are connected releasably to each other in order to ensure that the stack of wafer pockets 20 in the holding block 10 can be replaced. In this view, the strip showing the days of the week has not been applied. For illustration purposes, only the display surface 8 is depicted on which the strip showing the days of the week can be applied.

FIG. 7 shows another embodiment of a dispenser according to the invention with a rotatable indicator wheel 30, both in the opened position and also in the closed position. The indicator wheel 30 serves to identify the days of the week in an alternative manner to the strip showing the days of the week.

1. Wafer pocket booklet that can be inserted into a dispenser and fixed releasably therein, comprising a stack of at least two wafer pockets which each contain a wafer, and also a holding element for the stacked wafer pockets with which holding element the wafer pockets are connected to one another, wherein each wafer pocket has a wafer portion, which contains the wafer, and at least one residual portion which remains in the holding element when the wafer portion is removed, and wherein the respective residual portion remaining in the holding element is held and non-releasably fixed by means of at least one fixing means.

2. Wafer pocket booklet according to claim 1, characterized in that the respective residual portion is clamped in the holding element by means of the at least one fixing means.

3. Wafer pocket booklet according to claim 1, characterized in that at least one fixing means is designed in the form of a ridge or a spike or in the form of a receiving opening receiving a push-through element, or in that several such fixing means are present in combination.

4. Wafer pocket booklet according to claim 3, characterized in that at least one receiving opening is located in a sleeve arranged in the holding element.

5. Wafer pocket booklet according to claim 1, characterized in that the holding element contains at least one sleeve having a receiving opening, wherein the end of a respective push-through element is pushed into each receiving opening.

6. Wafer pocket booklet according to claim 5, characterized in that at least one push-through element is designed in the form of a rivet, a screw connection or a staple.

7. Wafer pocket booklet according to claim 1, characterized in that the holding element has a rear wall, side walls, a base plate and a cover plate and is open, on at least one side, to a storage space receiving the wafer pocket booklet in the dispenser.

8. Wafer pocket booklet according to claim 7, characterized in that the residual portions are clamped between the base plate and the cover plate.

9. Wafer pocket booklet according to either of claims 7 and 8, characterized in that, in order to fix the wafer pockets, the cover plate and/or the base plate have/has in each case a ridge and/or in each case at least one spike.

10. Dispenser containing a stack of at least two wafer pockets, which each contain a wafer, wherein each wafer pocket has a wafer portion, which contains the wafer, and at least one residual portion, which remains in the dispenser when the wafer portion is removed, and wherein the dispenser has a storage space, which receives the wafer pocket stack, and at least one dispensing opening through which a wafer pocket can in each case be dispensed from the dispenser in a dispensing direction, and wherein the wafer pocket stack is held in the dispenser by means of at least one fixing means, characterized in that the wafer pockets in the wafer pocket stack are combined and connected to one another by means of a holding element of a wafer pocket booklet secured releasably in the dispenser, by means of the residual portion of the wafer pockets being held and non-releasably fixed by means of the at least one fixing means.

11. Dispenser according to claim 10, characterized in that the holding element is arranged in the dispenser on a side of the dispenser opposite the dispensing opening for the wafer pockets.

12. Dispenser according to claim 10, characterized in that a grip opening allowing an uppermost wafer pocket to be pushed forward manually is introduced into a main outer surface of the dispenser.

13. Use of the dispenser according to claim 10 for storing and supplying medicament wafers for contraception or hormone replacement therapy.
